(19) United States
(12) Patent Application Publication
(10) Pub. No.: US 2025/0107671 A1
(43) Pub. Date: Apr. 3, 2025

(54) PROCESS FOR MANUFACTURING A LIGHTWEIGHT RETRACTABLE SHOWER DOOR ENCLOSURE AND A LIGHTWEIGHT SHOWER DOOR ENCLOSURE MANUFACTURED THEREBY

(71) Applicant: Cristopher Stover, Hicksville, OH (US)

(72) Inventor: Cristopher Stover, Hicksville, OH (US)

(21) Appl. No.: 18/753,127

(22) Filed: Jun. 25, 2024

Related U.S. Application Data
(60) Provisional application No. 63/541,326, filed on Sep. 29, 2023.

(51) Int. Cl. A47K 3/34; B29C 48/00; B29C 48/07; B29C 48/27; B29C 48/35; B29C 48/395; B29C 48/465; B29C 48/69; B29C 48/88; B29C 48/95; B29K 27/06; B29K 105/00; B29K 105/16; B29L 31/00

(52) U.S. Cl. CPC A47K 3/34; B29C 48/0022; B29C 48/022; B29C 48/07; B29C 48/272; B29C 48/35; B29C 48/395; B29C 48/465; B29C 48/69; B29C 48/9135; B29C 48/919; B29C 48/95; B29K 2027/06; B29K 2105/0032; B29K 2105/0038; B29K 2105/0044; B29K 2105/16; B29L 2031/724

(57) ABSTRACT

A method of manufacturing a lightweight, plastic shower door enclosure for enclosing a shower in a limited space environment includes providing a supply of a plastic polymer material for each part of the shower door enclosure to be manufactured, feeding the plastic polymer material to a rotating screw arranged within and along a central axis of a barrel feeder, controlling a rotation of the rotating screw to mix the plastic polymer material while compelling the mixed, plastic raw material forward through a heated portion of the barrel, ejecting the mixed, heated, plastic polymer material through an adapter and/or die as an extrudate supply for forming the each part and cutting the extrudate to the dimensions of the each part of the shower door enclosure.

### CROSS-REFERENCE TO RELATED APPLICATIONS

This application claims priority under 35 USC § 119 (e) from U.S. Provisional Patent Application No. 63/541,326, filed on Sep. 29, 2023 (“the provisional application”); the content of the provisional application is incorporated herein by reference.

### BACKGROUND OF THE INVENTION

The present invention relates broadly to shower and bath enclosures, including shower and bath doors. More specifically, the invention provides a process for manufacturing a lightweight, retractable shower door enclosure for use in limited space environments, such as recreational vehicles, campers, etc. and a shower door enclosure manufactured by the process.

Various types of shower doors are known for use with bathtubs and showers. For example, rigid glass (panel) and/or plastic doors are conventionally used to substantially enclose tubs and showers. Such conventional shower/tub enclosure doors or screens typically include a sliding mechanism, are hinged as a single hinged panel door or as a bi-fold door. But such rigid panel doors, when operating with a sliding mechanism, limit access space and do not allow a full entryway to the tub or shower. Hinged shower doors require space for the doors to swing to gain access to the tub or shower. Moreover, when not open, such sliding or hinged doors have the further disadvantage of taking up a considerable amount of space. The issue is particularly acute in limited-space environments, such as mobile homes and recreational vehicles. Also known for water containment applications are flexible, slidable shower curtains hung from a bar above a tub/shower opening. But while same are cheap and easily installed, they leak. Also used to contain water from a shower or tub enclosure are plastic sheets that can be pulled out to cover the shower opening and which are then rewound or refolded to conserve space when not in use. But these flexible, slidable shower curtains hung from a bar above a tub/shower opening are not successful from the standpoints of utility, cost and aesthetics for recreational vehicle applications.

Some of the known shower and tub doors for use in recreational vehicles and other locations in which space and weight are significant limitations, and methods of manufacturing same are the subject of patents. For example, U.S. Pat. No. 6,470,511 discloses a closure device for a shower enclosure comprising a shower entrance surround and replaceable shower screen assembly. FIGS. 1-5 therein detail a closure device that is used in conjunction with a shower enclosure where a distance 1 between walls 2 and 3 in which the closure device is mounted is substantially less than a width of the closure device, such that the closure devices is said to effectively increase a space inside the shower enclosure.

The curved shower screen enclosure of the '511 patent includes curved top and/or bottom rails and means for retaining upper and/or lower edges of the shower screen to the top and/or bottom rails when the shower screen is extended to enclose the tub or shower. The retaining means is necessary to prevent the shower screen from encroaching on the showering area inside the rails due to the tension of the spring in the retractable shower screen that urges the shower screen to take a straight path between a spring loaded roller and an engagement means when the shower screen is extended to enclose the shower. But there are certain limitations inherent in the retaining means described by the '511 patent in maintaining a curved configuration of the shower screen.

Also known is US Published application No. 2022/0400907 (“the '907 published application”), which discloses a retractable curved shower door said to overcome the shortcomings of known technologies such as that disclosed in the '511 patent and the like. In one embodiment, the '907 published application provides a retractable curved door assembly with a spring-loaded roller assembly having a reel structure configured to rotate about an axis of rotation thereof, a rail extending away from the reel structure in a direction perpendicular to the axis of rotation of the reel structure with at least a portion of the rail curving about an axis arranged parallel to the axis of rotation of the reel structure, a door end structure slidably engaging the rail; a flexible screen coupled to the reel structure and to the door end structure, and a tension element coupled to the reel structure and the door end structure. A greater tensile force is applied to the tension element than to the flexible screen when the door end structure is slid.

A problem associated with such known retractable door assemblies arises from the fact that most shower and tub enclosure doors are typically made of metal, which metal must be heated and extruded, which adds costs. Perhaps more importantly, however, conventional metal-made enclosure doors add weight to the RV in which it the metal-made doors are installed, which, as is known to the person skilled in the art, increases weight and, therefore, fuel costs.

### SUMMARY OF THE INVENTION

The present invention provides a method of manufacturing a lightweight, plastic shower door enclosure for enclosing a shower in a limited space environment, which overcomes the shortcomings of the known arts.

The invention provides a method of manufacturing a preferably plastic, lightweight retractable shower door enclosure for a bathtub or shower enclosure, which includes extruding plastic to form the retractable shower door enclosure's structural elements to realize the retractable enclosure/shower door enclosure that is lighter and in sections, and stronger than certain metal-based retractable shower enclosure sections. The retractable shower enclosures and assemblies produced according to the inventive process are ideally suited for use in limited-space environments, such as recreational vehicles (RVs), mobile homes, buses, ships, airplanes, without limitation. The use of the inventive lightweight, retractable shower enclosures/assemblies save fuel due to the lower weight when compared to metal designs.

In an embodiment, the invention provides a method of manufacturing a lightweight, plastic shower door enclosure for enclosing a shower in a limited space environment includes providing a supply of a plastic polymer material for each part of the shower door enclosure to be manufactured, feeding the plastic polymer material to a rotating screw arranged within and along a central axis of a barrel feeder, controlling a rotation of the rotating screw to mix the plastic polymer material while compelling the mixed, plastic raw material forward through a heated portion of the barrel, ejecting the mixed, heated, plastic polymer material through an adapter and/or die as an extrudate supply for forming the each part and cutting the extrudate to the dimensions of the each part of the shower door enclosure.

The supply of plastic polymer material is provided to a hopper with a feed throat to effect the feeding to the barrel and rotating screw. Preferably, the supply of plastic polymer material is heated to control a form and/or shape of the extrudate. A motor drives screw rotation through a gear box and thrust bearing, preferably an electric motor and most preferably a hi torque electric motor. For that matter, an inner diameter of the barrel decreases along an extent of the barrel from the feed location to the adapter and/or die. A desired extrudate shape and thickness is formed by the adaptor and/or die.

Preferably, the method further comprises processing the extrudate exiting the adaptor and/or die using a pull roller and cooling the extrudate prior to processing by the pull roller. The method requires cutting the extrudate with a cutting machine to realize a final shape of the each part and preferably, filtering the heated extrudate prior to processing in the adapter and/or die. The plastic polymer material is preferably polyvinyl chloride, and the barrel preferably is heated in reliance upon a proportional integral derivative (PID) controller. The cooling may be implemented by passing the extrudate through a cooling bath.

For that matter, the plastic polymer material preferably is defined by a plastic resin formula, which can include a photo stabilizer to render the each part more durable. The plastic resin formula also can include an anti-ultraviolet (UV) additive to render the each part more durable. And the invention includes a plastic, lightweight shower door enclosure comprising one or more parts manufactured according to the inventive method of manufacture. For that matter, it is preferable that the lightweight shower door enclosure be formed such that certain plastic-extruded parts comprising the shower door enclosure are formed with a thickness that is greater than a thickness of functionally-equivalent parts formed as part of a metal-based shower door enclosure. The method further includes preparing the PVC by providing 100 parts of PVC resin; adding 1-4 parts of heat stabilizer; adding 30-60 parts of a plasticizer for soft formulations; adding 0-50 parts filler; adding 0.5 to 2 ports internal lubricant; adding 5-10 parts impact modifier; adding 1-3 parts of a processing aid material; adding 01 to 0.5 parts of antioxidant; and adding pigments for color as needed. Preferably, the formula includes 100 parts PVC resin, 2 parts heat stabilizer, 45 parts plasticizer (if the PVC formulation is a soft formulation), 25 parts filler, 1 part internal lubricant, 5 parts impact modifier; 1.5 parts processing aid material, 0.25 parts antioxidant and pigment to effect coloring, as known to the person of ordinary skill in the art of coloring PVC-like materials.

These and other features and advantages of the invention are illustrated in the following drawings and are further described in the Detailed Description, which follows, the scope of which is identified in the appended claims.

### BRIEF DESCRIPTION OF THE DRAWING FIGURES

FIG. 1 presents an embodiment of a shower door enclosure manufactured according to the inventive process;

FIG. 2 presents an extruder may be used as part of an inventive plastic extrusion process to effect the inventive process;

FIG. 3 presents an embodiment of the inventive extrusion process by which parts of the inventive shower door enclosure are extruded through single screw extruder comprising a hopper and a die (FIG. 2), provided to a cooling bath and further processed by a pull roller before being finalized by a cutter or like instrument;

FIG. 4A presents an exemplary wall jamb assembly that is part of the retractable shower door enclosure and specific dimensions thereof;

FIG. 4B present and outline of the exemplary wall jam assembly of FIG. 4A;

FIG. 5 presents a comparison of the dimensions of an aluminum part that could be part of a conventional, metal-based shower enclosure (on the left in FIG. 5), where the right side of FIG. 5 shows a plastic part extruded according to the inventive process;

FIG. 6A presents one embodiment of the inventive process for manufacturing a retractable shower door enclosure for use in limited-space environments, such as a recreational vehicle;

FIG. 6B presents additional steps that may be practiced with the inventive process depicted in FIG. 5A;

FIG. 6C presents additional steps that may be practiced with the inventive process depicted in FIG. 6A; and

FIG. 6D presents an additional step that may be practiced with the inventive process depicted in FIG. 6A.

### DETAILED DESCRIPTION OF THE INVENTION

The following is a detailed description of example embodiments of the invention, which are presented in such detail as to clearly communicate the invention and are prepared to make such embodiments obvious to a person of ordinary skill in the art.

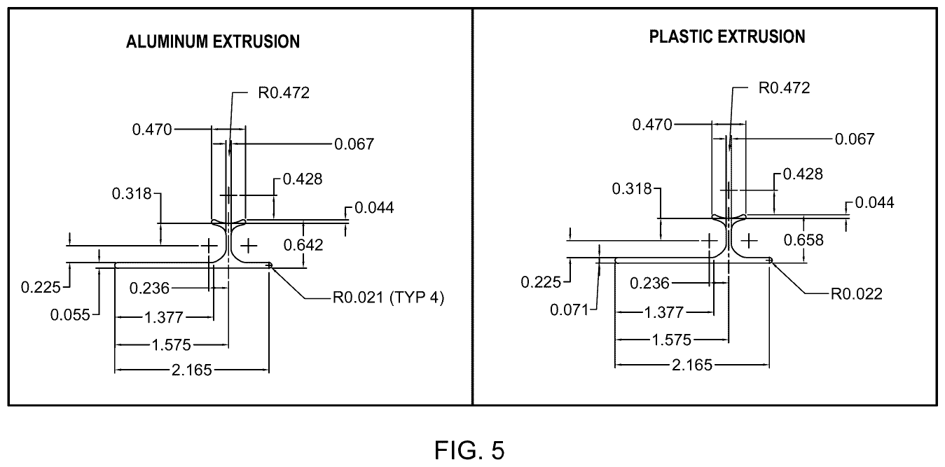

The inventive process or method provides for manufacturing a retractable shower door enclosure using plastic, such as polyvinyl chloride (PVC), without limitation, rather than metal (for example, aluminum), the steps or acts of which are described in detail in FIGS. 5A, 5B, 5C and 5D.

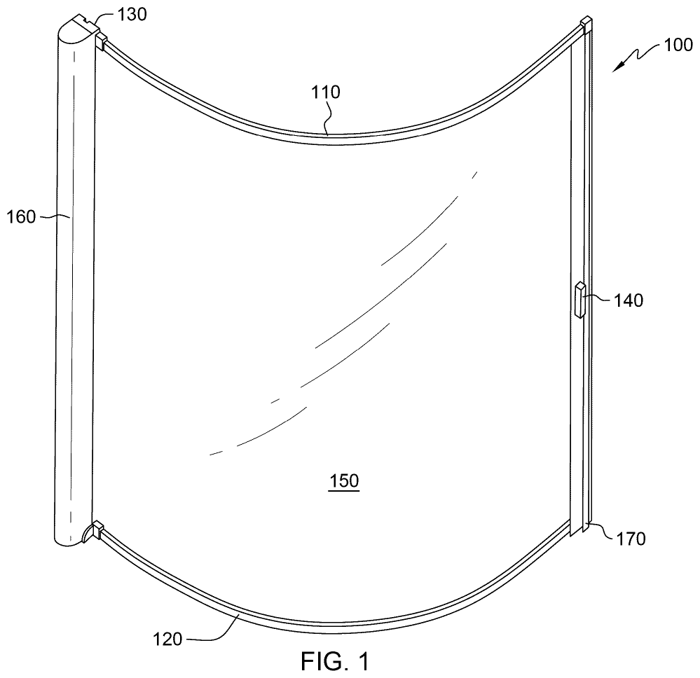

The inventive shower door assemblies, such as shower door enclosure 100 depicted in FIG. 1, include various structural and functional elements, such as a top rack 110, a bottom rack 120, a housing 160, a housing back 130, a handle 140, a wall jamb 170 and a film 150 (straight or curved depending on the particular design/space requirements). These plastic-based structural (and functional elements), as distinguished from those metal-based structural/functional elements manufactured using known metal extrusion processes are formed in reliance upon a plastics extrusion process.

The plastic-based shower door assemblies realized by the inventive process are lightweight, retractable shower door assemblies. The shower door portion or enclosure (150) of the enclosure 100 is grasped at the handle 140 and pulled (drawn) out of the housing 160 and detachably attaches to wall jamb 170 to effect a shower enclosure. The shower door portion is allowed to be retracted back into the housing 160 when non-deployed, in a non-deployed state. The film material comprising the shower door portion 150 is flexible enough to be wound and unwound on a spool (not shown) within the housing 160 in its non-deployed state.

The metal-based and plastic-based extrusion processes are distinguishable in many ways. Plastic Profile Extrusion (PPE) is different. PPE is a manufacturing process through which plastic is melted, shaped into a continuous profile, and cut to length. This PPE extrusion process is used in the production of a wide variety of shapes and channels. In this process, raw plastic is fed into a heated extruder cavity or cylinder and the extruded part is “pushed” out while its shape is controlled by the shape of the die.

Aluminum extrusion employs a conventional technique of forcing aluminum alloy material into a die having a predetermined cross-sectional shape. A substantial ram pushes the aluminum via the die, where the aluminum exits from the die aperture as the desired, extruded, aluminum part. The extruded aluminum part emerges in the exact form of the die and is typically hauled off along a runout table when this happens. The above-mentioned aluminum extrusion process is quite straightforward and understood to be comprehensible on a fundamental level, where the force to extrude aluminum is comparable to that force one is compelled to apply when compressing a tube of toothpaste with your hands. The toothpaste comes out in the shape of the tube's aperture when you squeeze. The toothpaste tube's opening majorly performs the same purpose as an extrusion die.

The downside of aluminum extruded parts for limited-space shower enclosures is that the parts of a shower door enclosure formed from extruded aluminum are rigid, are heavier than. But as explained above, the retractable shower door assemblies formed under the inventive process are lighter and in sections, are possibly stronger than corresponding sections of conventional metal-formed retractable shower door assemblies. As such, the retractable shower door assemblies so formed are ideally suited for use in limited-space environments, such as recreational vehicles (RVs), mobile homes, buses, ships, airplanes, without limitation.

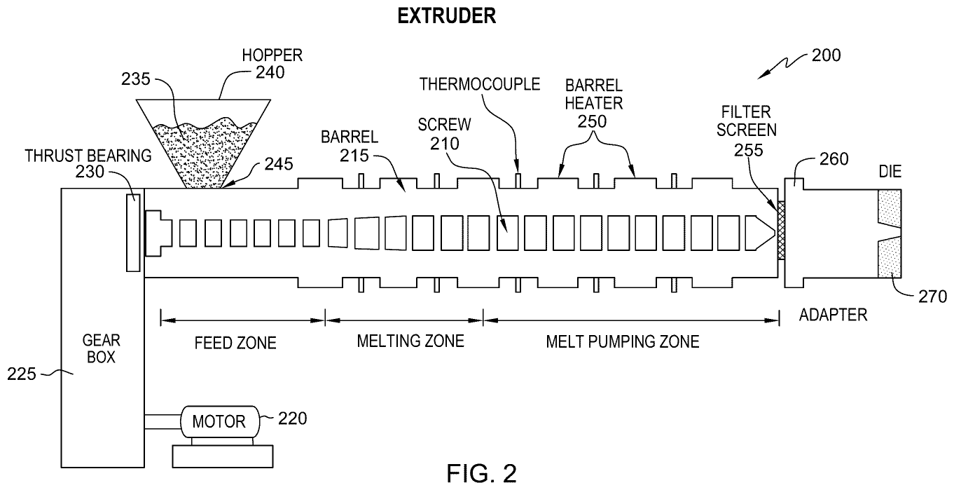

FIG. 2 herein presents an embodiment of an extruder 200 that is used in the inventive process for manufacturing a lightweight, retractable shower door enclosure thereby. Extruder 200 is a screw design. That is, the extruder includes a screw 210 enclosed by barrel 215 and turned by motor 220, which motor drives the gears in gear box 225 and turns the screw 210 in reliance upon a thrust bearing 230.

The raw material for the inventive process preferably comprises thermoplastic 235, for example, PVC, but is not limited to this type of thermoplastic. Thermoplastics are polymers that may melt when heated. Thermoplastics can include polyethylene. Polyvinyl chloride (PVC), etc. Preferably, the thermoplastic material 235 is provided in the form of granulates, such that it can be gravity fed into the hopper 240 and through the feed throat 245 to deliver it on the rotating screw (drops onto the rotating screw); the screw rotation is provided by the motor 220, which preferably is electric. The skilled person should recognize that the screw design may vary without deviating from the scope and spirit of the invention. This should be apparent because the motor requirements are dependent on the material used in the plastic extrusion process and the specifications of the particular retractable shower door enclosure product design.

The rotation of the screw forces the plastic granulate material 235 forward through at least one heated barrel 250. As the plastic (granulate) material 235 is conveyed through the barrel 215, an internal channel or thread of the screw decreases, thus compressing the plastic being compelled through. Three or more independent proportional integral derivative (PID) controllers, creating zones of gradually increasing temperature, heat the barrel and the plastic granulate material 235 therein. The plastic melt temperature is normally higher than the set temperature for the PID controllers, whereby the plastic material 235 receives additional heat. This additional heat is generated through a combination of compressive force and shear friction (shear heat), as well as the heat provided by the PIDs.

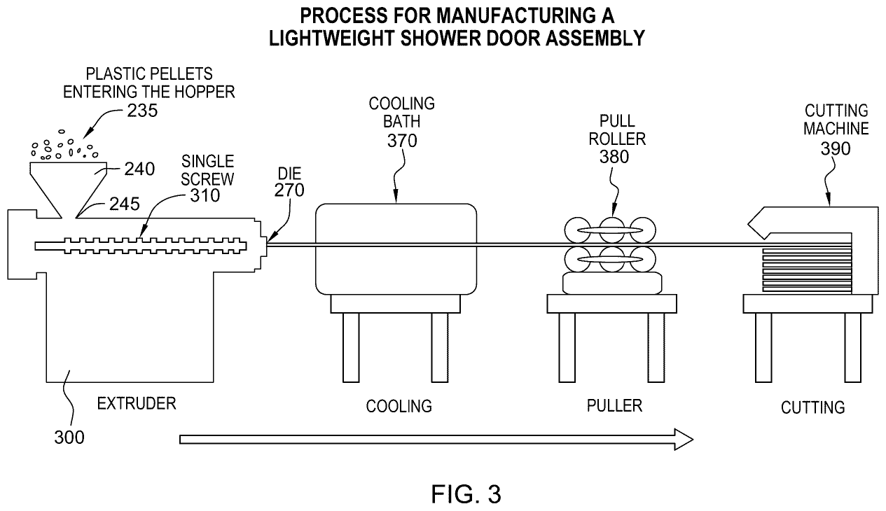

When the plastic melt (235) reaches the end of the screw (i.e., the end of the melting zone) the plastic melt is well mixed and pushed through a filter screen pack or screen 255, supported by a breaker plate (adapter) 260; The step filters contaminants and removes the materials' rotational memory. The filtered melt is pushed through the die 270 (also see FIG. 3). The die 270 gives the final extruded feed product the desired profile and shape.

After exiting the extruder (as the die 270), the shaped extrudate preferably is pulled and cooled, as part of the plastic extrusion-based process for manufacturing a lightweight, Shower Door Enclosure. The cooling technique used in the inventive process is dependent on the profile and shape of extrudate. FIG. 3 depicts the inventive manufacturing process by which parts/elements of the lightweight shower door enclosure are formed with an extrudate in reliance upon the single screw extruder 300 (including hopper 240 and die 270. The extrudate is provided to cooling bath 370; preferably, a pull roller 380 draws and rolls the cooled extrudate before being finally shaped by cutter/cutting machine 390. The cutting machine 390 finalizes the shape of the part or section of the lightweight, retractable shower door enclosure.

Plastic extruded parts or elements, such as those formed of polyvinyl chloride (PVC), acrylonitrile butadiene styrene (ABS), polycarbonate (PC), polypropylene (PP), Polyethylene (PE) and fiber reinforced plastic are preferable because they are strong, lightweight, flexible, durable and versatile, as compared to metals such as aluminum and other extrudable metal alloys. PVC is preferred, particularly a modified PVC formula for the raw material used in the inventive plastic extrusion process. To that end, the inventive process includes a step whereby the special PVC formula is relied upon to form the preferred raw PVC material. ABS and PC also may be preferable, as ABS is good for strength and for dimensional stability (but suffers from high cost and undesirable weatherability), and PC is good for strength and dimensional stability (but also high in cost).

Neither PP nor PE have sufficient strength (shoe hardness 70 vs 82 for PVC and 62 vs 82 for PVC, respectively. And fiber-reinforced plastic is good for strength but bad for surface finish—it is very difficult to achieve a uniform surface, particularly a glossy surface, by extruding fiber reinforced plastic. As such, PVC stands out as a preferred raw material because it displays a good hardness (shore hardness of about 82), realizes a great surface finish through the inventive process, good dimensional stability (in repeated extrusions), good weatherability (anti ultraviolet (UV) light and anti-aging), allows for efficient productivity and minimal cost. For that matter, in the step of forming the PVC material for use in the inventive process, the PVC material is modified to increase its hardness and weatherability.

In an embodiment, the modified PVC formula is as follows:
PVC Resin: 100 parts;
Heat Stabilizer (Calcium zinc stabilizer): 2-4 parts;
Plasticizer (used only for soft formulations): 30-60 parts;
Filler (Calcium carbonate, talc, wollastonite): 0-50 parts;
Internal Lubricant (Stearic acid, stearate): 0.5-2 parts;
External Lubricant (Polyethylene wax, oxidized polyethylene wax): 0.1-1 part;
Impact Modifier (Acrylic acid copolymer): 5-10 parts;
Processing Aid: 1-3 parts;
Antioxidant: 0.1-0.5 parts;
Pigments and Colorants: added as needed.

Please note that an exemplary MFR may be found at any of the following
manufacturers
LG Chemical;
Shin-Etsu Chemical; and
Formosa Plastic Corporation.

The inventive process relies upon a proper melt flow rate that is suitable for the inventive process. In the inventive process, the melt flow rate (MFR) must be precisely controlled to match the extrusion temperature and extrusion speed to realize an ideal resulting surface for the extruded parts. PVC plastic extruded parts or elements are significantly lighter compared to aluminum (or other metallic or metallic alloy) extruded parts or section of a similar construction by over 50%. This is a substantial weight-reduction factor for a retractable shower enclosure installed in an RV or private plane. Moreover, the cost for PVC-extruded parts, as compared to aluminum-extruded parts, is significantly cheaper to build and maintain (in some cases); at least 50% cheaper than aluminum of the same weight. And PVC's inherent flame retardant properties and excellent electrical insulation properties make it ideal for installation in any pace-limited applications, including the flexibly, retractable door enclosures and assemblies manufactured according to the inventive process described herein.

For that matter, while plastic extruded parts may be inherently relatively weaker than the aluminum extruded parts of the same construction, the inventive process for manufacturing the flexible, retractable shower door assemblies and shower door assemblies formed therewith compensate for any inherent material weakness in the extruded part construction. That is, in order to achieve strength similar to that of an aluminum-formed structural element, the inventive process has redesigned the profile of the extruded plastic parts or elements such that the redesigned profiles increase the PVC extrusion profile strength. The inventive process does so by increasing the material wall thickness of particular areas.

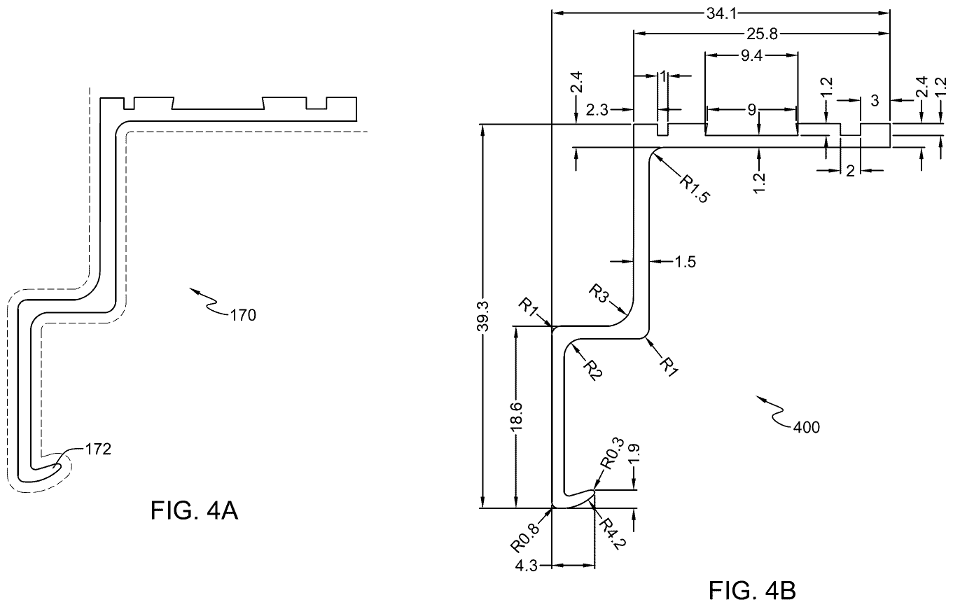

FIGS. 4A and 4B present an example of a wall jamb 170 that is part of the retractable shower door enclosure 200, described above (see FIG. 1). The wall jamb 170 includes a latching hook 172, by which the handle 140 comes across and latches (see element 140 in FIG. 1, to which the hook element in the left of FIG. 4B connects) The wall jamb 170 is an extrusion, where its latching hook 172 mates to the plastic handle 140. The wall jamb mounts to the shower wall opposite of a housing canister. Please note that the films used for the shower curtain material (150; FIG. 1) are preferably polyethylene terephthalate (PET) (sometimes referred to as polyester) film. Preferably, the film displays a durometer and thickness that allows it to wrap around a spring loaded roll-tube inside the housing canister.

The skilled person will note that FIGS. 4A and 4B present a single embodiment for exemplary purposes only and that the dimensions used for conventional metal extruded parts will be different for plastic-extruded parts, for example, sometimes thicker (see FIG. 4). Dimensions shown in the exemplary FIG. 4 embodiment are in mm. For that matter, where the added material to increase overall strength sees an increased thickness primarily at the inner dimension so that the modification of the part does not affect the enclosure's overall outer dimensions. But in some cases, the increased thickness could affect the corresponding parts (e.g., connecting parts), where both parts would have to be modified (according to the inventive principles) to ensure that the final enclosure meets the overall specification for the parts or sections if they had been conventionally made.

The specific gravity of PVC is on average only 50% of that of aluminum, so even with increased thickness ranging by 15%-30%, the weight saving is ranging from 20% to 35%. And surface smoothness is important, if not from an ergonomic perspective but then from an ornamental look and feel for the final shower door enclosure. For that matter, the inventive process for manufacturing the inventive shower enclosure/shower door enclosure can produce PVC plastic extruded parts with a smooth surface, because smooth surfaces in PVC extruded parts do not come naturally. The inventive manufacturing process fine tunes and adjusts the plastic resin formula, along with the extrusion process parameters, e.g., temperature, speed, cooling method, etc. to achieve a smooth surface. Mastery of the process parameters is the key for success to the PVC plastic extrusion. Mastery of polishing the inside surface of the extrusion die allows for the melted PVC pellets to pass through the die with the least amount of resistance and friction. This polishing process allows for a bright smooth and gloss finish when done correctly, which is aesthetically pleasing and may appear to be a powder-coated or painted aluminum part (finish).

FIG. 5 herein presents a comparison of the dimensions of an aluminum part that could be part of a conventional, metal-based shower enclosure (on the left in FIG. 5), where the right side of FIG. 5 shows a plastic part extruded according to the inventive process, which is functionally equivalent. Please note that the thickness of the aluminum-extruded parts formed according to the inventive process can be thicker than a thickness of certain dimensions of the metal-based parts, for example, 0.658 (plastic) as compared 0.642 (aluminum) and 0.071 (plastic) as distinguished from 0.055. The added thickness t the plastic-extruded parts adds strength so that said plastic extruded parts is as strong as the smaller dimension aluminum extruded parts. Of course, the additional plastic material to realize the added thickness still finds an overall weight of the plastic-based enclosures significantly lighter than those aluminum-based enclosures.

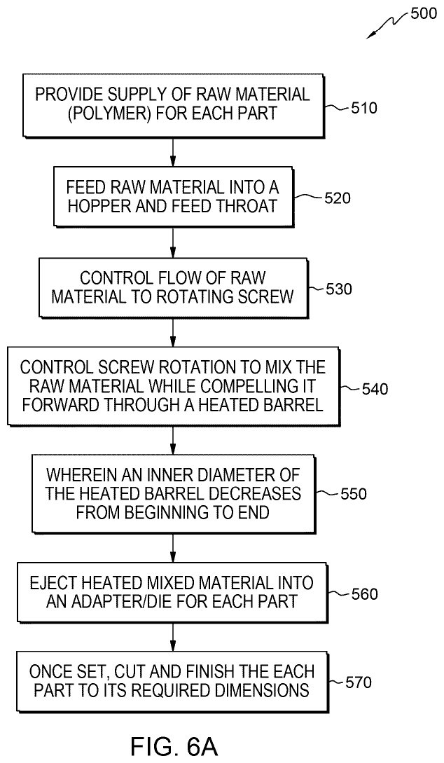

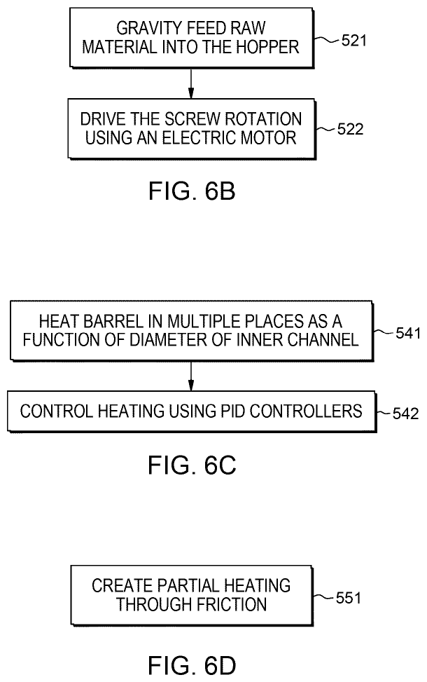

FIGS. 6A, 6B, 6C and 6D present various steps undertaken to implement the inventive process 500 of manufacturing a flexible, plastic, lightweight, retractable shower door enclosure for use in limited-space environments. Step 510 (FIG. 6A) of the inventive process requires providing a supply of raw material 235 (polymer) for each part to be extruded. Step 520 requires feeding the raw material (preferably a thermoplastic such as PVC) 235 into a hopper 240 and feed throat 245 of the hopper (FIG. 3). Step 530 requires controlling a flow of the raw material 235 (from the hopper feed throat 245) to the rotating screw 210 (FIG. 2) (a single screw 310 in the FIG. 3 embodiment) and step 540 requires controlling the screw rotation to mix the raw material while compelling the raw material (plastic) forward through a heated barrel 215 (heated by barrel heater 250). The screw rotation is provided by a motor, gear box and thrust bearing, as shown in FIG. 2.

In step 550, an inner diameter of the heated barrel 215 decreases from beginning to end (from left to right in FIG. 3). In step 560, the heated, mixed material 235 is ejected into the adapter 260/die 270 (for each part). In step 570, the extruded portion (extrudate) exiting the die 270 in its desired shape are input to cutting machine 390, where the shaped feed is cut and finished to a part's, or a section's, required dimensions. A step whereby an inside surface of the die 270 is polished to reduce friction between the melted material and that inside die surface. Put another way, polishing the inside surface of the extrusion die 270 allows for the melted PVC pellets to pass through the die smoothly (with minimal friction with the inner die surface)

Preferably, upon exiting the die 270, the shaped extrudate material is cooled in a cooling bath 370. Most preferably, the system (FIG. 3) includes a pull roller 380 to which the extruded, shaped material is further adjusted prior to being cut by the cutting machine 390 into desired parts/sections. FIGS. 4A and 4B depict one of the finished parts manufactured according to the inventive process in reliance upon the inventive process (see, for example, the exemplary embodiment of FIG. 3). Preferably, the process includes a step 521 (FIG. 6B) by which the raw material 235 is gravity fed into the hopper 240 and in step 522, the screw 210 rotation is driven using an electric motor 220.

Preferably, in a step 541 (FIG. 6C), the barrel 215 is heated at multiple places as a function of diameter of and inner channel that extends from around the feed throat 245 substantially along a central axis of the barrel 215 in which the screw turns through the feed zone, melting zone and melt pumping zone. At step 542, the heating is controlled using the above-described PID controllers.

Preferably, in a step 551, the plastic material is partially heated through friction (FIG. 6D). And preferably, the plastic is heated in a range of 185 to 195 degrees Centigrade, most preferably to about 190 degrees C. Also preferably, the screw is turned at 10-18 meter/minute, most preferably 12 meters/minute. Preferably, cooling is implemented by controlling application of cycling water and all surfaces are polished. In some embodiments, the contact surfaces of the dies are chrome plated to achieve a highly glossy surface.

The PVC plastic extruded parts formed according to the inventive process are quite reliable and display a long life span. In order to make the PVC plastic more durable for some applications, the inventive process provides for adjusting the plastic resin formula. This is typically done by adding an anti-UV additive to the material 235. Anti-UV additives may include a photo-stabilizer 944, which maintains color, gloss level and prevents degradation of chemical bonds in the polymer chains. UV stabilizers contain two types of light stabilizers: Ultraviolet Light Absorbers (UVA) and Hindered-Amine Light Stabilizers (HALS), used individually or as blends. UVA filters harmful UV light and helps prevent color change and delamination of coatings, adhesives, and sealants. HALS trap free radicals once they are formed and are effective in retaining surface properties such as gloss and preventing cracking and chalking of paints.

The present disclosure, in connection with the accompanied drawings, describes example configurations that are not representative of all the examples that may be implemented or all configurations that are within the scope of this disclosure. The term “exemplary” should not be construed as “preferred” or “advantageous compared to other examples” but rather “an illustration, an instance or an example.” By reading this disclosure, including the description of the embodiments and the drawings, it will be appreciated by a person of ordinary skills in the art that the technology disclosed herein may be implemented using alternative embodiments. The person of ordinary skill in the art would appreciate that the embodiments, or certain features of the embodiments described herein, may be combined to arrive at yet other embodiments for practicing the technology described in the present disclosure. Thus, the disclosure is not limited to the examples and designs described herein but is to be accorded the broadest scope consistent with the principles and novel features disclosed herein.

What is claimed is:

1. A method of manufacturing a lightweight, plastic shower door enclosure for enclosing a shower in a limited space environment, the method comprising acts of:
providing a supply of a plastic polymer material for each part of the shower door enclosure to be manufactured;
feeding the plastic polymer material to a rotating screw arranged within and along a central axis of a barrel feeder;
controlling a rotation of the rotating screw to mix the plastic polymer material while compelling the mixed, plastic raw material forward through a heated portion of the barrel;
ejecting the mixed, heated, plastic polymer material through an adapter and/or die as an extrudate supply for forming the each part; and
cutting the extrudate to the dimensions of the each part of the shower door enclosure.

2. The method of manufacturing of claim 1, wherein the supply of plastic polymer material is provided to a hopper with a feed throat to effect the feeding to the barrel and rotating screw.

3. The method of manufacturing of claim 1, wherein the supply of plastic polymer material is heated to control a form and/or shape of the extrudate.

4. The method of manufacturing of claim 3, wherein a motor drives screw rotation through a gear box and thrust bearing.

5. The method of manufacturing of claim 1, wherein an inner diameter of the barrel decreases along an extent of the barrel from the feed location to the adapter and/or die.

6. The method of manufacturing of claim 1, wherein a desired extrudate shape and thickness is formed by the adaptor and/or die.

7. The method of manufacturing of claim 1, further comprising processing the extrudate exiting the adaptor and/or die using a pull roller.

8. The method of manufacturing of claim 1, further comprising cooling the extrudate prior to processing by the pull roller.

9. The method of manufacturing of claim 1, further comprising cutting the extrudate with a cutting machine to realize a final shape of the each part.

10. The method of manufacturing of claim 6, further including filtering the heated extrudate prior to processing in the adapter and/or die.

11. The method of manufacturing of claim 1, wherein the plastic polymer material is polyvinyl chloride (PVC).

12. The method of manufacturing of claim 1, wherein the extracting further includes first polishing an inside surface of the die from which the heated plastic polymer material is extruded in order to reduce friction between the heated plastic polymer material and the inner die surface.

13. The method of manufacturing of claim 1, wherein the barrel is heated in reliance upon a proportional integral derivative (PID) controller.

14. The method of manufacturing of claim 8, wherein the cooling is implemented by cooling the extrudate in a cooling bath.

15. The method of manufacture of claim 1, wherein the plastic polymer material is defined by a plastic resin formula.

16. The method of manufacture of claim 15, wherein the plastic resin formula includes a photo stabilizer to render the each part more durable.

17. The method of manufacture of claim 15, wherein the plastic resin formula includes an anti-ultraviolet (UV) additive to render the each part more durable.

18. The method of manufacture of claim 1, further including preparing the PVC as follows:
provide 100 parts of PVC resin;
add 1-4 parts of heat stabilizer;
add 30-60 parts of a plasticizer for soft formulations;
add 0-50 parts filler;
add 0.5 to 2 parts internal lubricant'
add 5-10 parts impact modifier;
add 1-3 parts of a processing aid material;
add 01 to 0.5 parts of antioxidant; and
add pigments for color as needed.

19. A plastic, lightweight shower door enclosure comprising one or more parts manufactured according to the method of manufacture of claim 1.

20. The plastic, lightweight shower door enclosure of claim 18, wherein certain plastic-extruded parts comprising the shower door enclosure are formed with a thickness that is greater than a thickness of functionally-equivalent parts formed as part of a metal-based shower door enclosure.
